(19) United States
(12) Patent Application Publication
(10) Pub. No.: US 2024/0020769 A1
(43) Pub. Date: Jan. 18, 2024

(54) PROCESSING DATA FOR ADMINISTERING STABLE VALUE PRODUCTS WITH POOLING AND CAPPING OF RISK FEATURES UTILIZING COMPUTER-IMPLEMENTED METHODS AND COMPUTER SYSTEMS

(71) Applicant: Atlas Financial Partners, LLC, New York, NY (US)

(72) Inventors: John Coleman, Norfolk, MA (US); Clifford R. Eisler, New York, NY (US)

(21) Appl. No.: 18/313,913

(22) Filed: May 8, 2023

Related U.S. Application Data
(63) Continuation of application No. 17/579,343, filed on Jan. 19, 2022, now abandoned.
Application No. 17/579,343 is a continuation of application No. 17/021,363, filed on Sep. 15, 2020, now abandoned.
Application No. 17/021,363 is a continuation of application No. 15/915,542, filed on Mar. 8, 2018, now abandoned.

(51) Int. Cl. G06Q 40/08

(52) U.S. Cl. CPC G06Q 40/08

(57) ABSTRACT

In some embodiments, the instant invention is directed to a computer-implemented method, including: electronically receiving, over a computer network, from a computer system life insurance data for a plurality of policyholders associated with a pooled stable value wrap (SVW) financial product having a predetermine capping; where the predetermined capping is an X percent limit to be maintained for a ratio of a pre-withdrawal fair market value of an investment portfolio to a pre-withdrawal total notional stable value account; automatically classifying a policyholder into a class based on the predetermined capping; electronically receiving investment data resulted from investing investment assets in an investment option; automatically partitioning the investment assets into an investment pool; automatically calculating any modifications to the life insurance data based on: the pre-withdrawal fair market value of the investment pool, the first pre-withdrawal total notional stable value account, and a write-down testing for the class.

### RELATED APPLICATIONS

This application is a continuation of U.S. patent application Ser. No. 17/579,343, filed Jan. 19, 2022, which is a continuation of U.S. patent application Ser. No. 17/021,363, filed Sep. 15, 2020, which is a continuation of U.S. patent application Ser. No. 15/915,542, filed Mar. 8, 2018, which is a continuation of U.S. patent application Ser. No. 14/727,533, filed Jun. 1, 2015, which claims the priority of U.S. provisional application Ser. No. 62/005,116, filed on May 30, 2014, which are incorporated herein by reference in their entirety for all purposes.

### TECHNICAL FIELD

In an embodiment, the present invention relates to processing data for administering financial products and, more particularly, stable value products.

### BACKGROUND

In some embodiments, the present invention relates to financial products and, more particularly, methods and systems for administering a stable value wrap financial product with pooling among owners and capping of risk features for use in the bank owned life insurance (“BOLI”) market and/or corporate owned life insurance (“COLT”) market and/or in other markets where purchasers require a stable value wrap financial product.

In some embodiments, the terms “Stable Value Wrap Financial product(s)” and “SVW Financial product(s)” identify certain types of financial productual agreements among parties that are designed for the BOLI and COLI markets and offered in conjunction with an investment portfolio which together is made available as a separate account investment option in a private placement variable universal life insurance (“PPVUL”) policy underwritten by an Insurance Carrier. In some embodiments, a bank, corporation, and/or trust established by the bank or corporation, would be a Policyholder which is owner and beneficiary of multiple PPVUL policies insuring employees or former employees who were employees at issue.

In some embodiments, the SVW Financial product itself can be offered by a bank, financial products company, and/or insurance carrier (“SVW Provider”). In some embodiments, insurance carriers may file their SVW Financial product with the state insurance commissioner as a synthetic guaranteed investment financial product.

### SUMMARY OF INVENTION

In some embodiments, the instant invention is directed to a computer-implemented method that at least includes the steps of: electronically and periodically receiving, over a computer network, from at least one computer system associated with at least one life insurance carrier, by a specifically programmed data processing computer system, life insurance data for a plurality of policyholders associated with at least one pooled stable value wrap (SVW) financial product having a predetermine capping; where the at least one pooled stable value wrap (SVW) financial product covers: (i) at least 10 policyholders, (ii) at least $100 million of a notional stable value account, and (iii) at least a one year period of operation; where the predetermined capping is an X percent limit to be maintained for a ratio of a pre-withdrawal fair market value of an investment portfolio to a pre-withdrawal total notional stable value account for the at least 10 policyholders; automatically classifying, by the specifically programmed data processing computer system, in real time, at least one first policyholder into at least one class based on the predetermined capping applicable to the at least one first policyholder; electronically and periodically receiving, by the specifically programmed data processing computer system, over the computer system, from a computer system associated with a financial trading institution, investment data resulted from investing in at least one investment option associated with the at least one pooled SVW financial product with the predetermined capping; automatically partitioning, by the specifically programmed data processing computer system, in real time, investment assets, underlying the at least one investment option associated with the pooled SVW financial product with the predetermined capping, into at least one investment pool, based, at least in part, on an ownership share in the investment assets of the at least one first policyholder in the at least one class based on the predetermined capping applicable to the at least one first policyholder; automatically calculating, by the specifically programmed data processing computer system, in real time, at least one interest crediting rate to be credited to a first notional stable value account for the at least one first policyholder based, at least in part, on: i) the life insurance data, and ii) the investment data; automatically calculating, by the specifically programmed data processing computer system, in real time, the pre-withdrawal fair market value of the at least one investment pool, based, at least in part, on: i) the life insurance data, and ii) the investment data; automatically calculating, by the specifically programmed data processing computer system, in real time a first pre-withdrawal total notional stable value account for the at least one first policyholder based, at least in part, on: i) the at least one interest crediting rate to be credited to the first notional stable value account for the at least one first policyholder, and ii) the life insurance data; automatically calculating, by the specifically programmed data processing computer system, in real time, any modifications to the life insurance data, based at least in part, on: i) the pre-withdrawal fair market value of the at least one investment pool, ii) the first pre-withdrawal total notional stable value account for the at least one first policyholder, and iii) a write-down testing for the class based on the predetermined capping for the at least one first policyholder; electronically and automatically transmitting, by the specifically programmed data processing computer system, in real time, verification of the life insurance data or modifications to the life insurance data back to the computer system associated with the at least one life insurance carrier.

In some embodiments, the at least one investment option includes an actively managed investment strategy.

In some embodiments, the transmitting of the life insurance data or modifications to the life insurance data back to the at least one life insurance carrier is performed within 3 business days after the investment data is received.

In some embodiments, the life insurance data includes at least one of the following: (a) allocations, (b) net premium deposits, (c) loan repayments, (d) partial surrenders, (e) surrenders, (f) loans, (g) death benefits, (h) transfers between investment alternatives, and (i) life insurance product deductions.

In some embodiments, the pooled SVW financial product with the predetermined capping is utilized by more than one insurance carrier and the life insurance data is received from more than one life insurance carrier.

In some embodiments, the pooled SVW financial product with the predetermined capping is associated with more than one investment option.

In some embodiments, the investment data is received from multiple independent investment portfolios for the same investment option.

In some embodiments, the instant invention is directed to a computer-implemented system, including at least the following components: at least one specialized computer machine, including: a non-transient memory having at least one region for storing a particular computer executable program code; and at least one processor for executing the particular program code stored in the non-transient memory, where the particular program code is configured to at least perform the following operations upon being executed by the at least one processor: electronically and periodically receiving, over a computer network, from at least one computer system associated with at least one life insurance carrier life insurance data for a plurality of policyholders associated with at least one pooled stable value wrap (SVW) financial product having a predetermine capping; where the at least one pooled stable value wrap (SVW) financial product covers: (i) at least 10 policyholders, (ii) at least $100 million of a notional stable value account, and (iii) at least a one year period of operation; where the predetermined capping is an X percent limit to be maintained for a ratio of a pre-withdrawal fair market value of an investment portfolio to a pre-withdrawal total notional stable value account for the at least 10 policyholders; automatically classifying, in real time, at least one first policyholder into at least one class based on the predetermined capping applicable to the at least one first policyholder; electronically and periodically receiving, over the computer system, from a computer system associated with a financial trading institution, investment data resulted from investing in at least one investment option associated with the at least one pooled SVW financial product with the predetermined capping; automatically partitioning, in real time, investment assets, underlying the at least one investment option associated with the pooled SVW financial product with the predetermined capping, into at least one investment pool, based, at least in part, on an ownership share in the investment assets of the at least one first policyholder in the at least one class based on the predetermined capping applicable to the at least one first policyholder; automatically calculating, in real time, at least one interest crediting rate to be credited to a first notional stable value account for the at least one first policyholder based, at least in part, on: i) the life insurance data, and ii) the investment data; automatically calculating, in real time, the pre-withdrawal fair market value of the at least one investment pool, based, at least in part, on: i) the life insurance data, and ii) the investment data; automatically calculating, in real time a first pre-withdrawal total notional stable value account for the at least one first policyholder based, at least in part, on: i) the at least one interest crediting rate to be credited to the first notional stable value account for the at least one first policyholder, and ii) the life insurance data; automatically calculating, in real time, any modifications to the life insurance data, based at least in part, on: i) the pre-withdrawal fair market value of the at least one investment pool, ii) the first pre-withdrawal total notional stable value account for the at least one first policyholder, and iii) a write-down testing for the class based on the predetermined capping for the at least one first policyholder; and electronically and automatically transmitting, in real time, verification of the life insurance data or modifications to the life insurance data back to the computer system associated with the at least one life insurance carrier.

### BRIEF DESCRIPTION OF THE DRAWINGS

The present invention will be further explained with reference to the attached figures. The figures constitute a part of this specification and include illustrative embodiments of the present invention and illustrate various objects and features thereof. Specific functional details disclosed herein are not to be interpreted as limiting, but merely as a representative basis for teaching one skilled in the art to variously employ the present invention.

FIGS. 1 and 2 illustrate some aspect of an exemplary process/administration structure according to some embodiments of the instant invention.

FIG. 3 illustrates an exemplary computer system architecture according to some embodiments of the invention.

FIG. 4 illustrates yet another exemplary computer system architecture according to some embodiments of the invention.

The figures constitute a part of this specification and include illustrative embodiments of the present invention and illustrate various objects and features thereof. Further, the figures are not necessarily to scale, some features may be exaggerated to show details of particular components. In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ the present invention.

### DETAILED DESCRIPTION

Throughout the specification and claims, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

In some embodiments, the processing data for administering stable value products of the present invention is configured for a particular SVW Financial product designed for the BOLI and COLI markets which can be designed so each bank or trust Policyholder has its own, unique SVW Financial product wrapping all the PPVUL policies owned by the Policyholder. In some embodiments, the processing data for administering stable value products of the present invention is configured for allowing the SVW Provider to provide a stable value crediting rate facility for the Policyholder by establishing a notional stable value account which accretes based on a non-negative interest crediting rate and/or tracks the Policyholder's share of the investment portfolio for the separate account investment option chosen by the Policyholder. In some embodiments, the processing data for administering stable value products of the present invention is configured for calculating the cash value payable to the Policyholder upon surrender which can be the amount in the notional stable value account rather than the Policyholder's share of the fair market value of the investment portfolio. In some embodiments, the processing data for administering stable value products of the present invention is configured for utilizing the interest crediting rate that is used to accrete the notional stable value account which can be reset on a periodic basis based on the value of the notional stable value account, the Policyholder's share of the fair market value of the investment portfolio, and/or various other similarly suitable variables specific to the Policyholder and investment portfolio. In some embodiments, the processing data for administering stable value products of the present invention is configured for utilizing the value of the notional stable value account that converges in a smooth, non-decreasing progression to the fair market value of the Policyholder's share of the investment portfolio while avoiding fluctuations, and specifically decreases, in the fair market value of the Policyholder's share of the investment portfolio which occur with mark-to-market accounting used for separate accounts. In some embodiments, the processing data for administering stable value products of the present invention is configured so that the SVW Provider is required to pay the excess of the notional stable value account over the Policyholder's share of the fair market value of the investment portfolio if the Policyholder surrenders while meeting qualifying conditions required for notional stable value account payouts which are stipulated in the SVW Financial product.

In some embodiments, the processing data for administering stable value products of the present invention is configured to account for SVW Financial products offered in the BOLI and COLI markets that incorporate a maximum risk assumed by the SVW Provider feature called “Capping” where the maximum payout under the SVW Financial product is capped so that if the excess of the notional stable value account over the Policyholder's share of the fair market value of the investment portfolio exceeds a percentage, “Cap”, of the notional stable value account, then the notional stable value account is written down so that such excess is equal to the Cap times the notional stable value account (“Capped” or “Capping”).

In some embodiments, the processing data for administering stable value products of the present invention is configured so that the buying and/or selling of separate account securities in PPVUL policies to be performed on a timely basis (e.g., predetermined triggered time basis, periodic time basis, etc.) to eliminate losses due to market movements between the time of the transaction and the time of the execution of the buy or sale. In some embodiments, the processing data for administering stable value products of the present invention is configured for calculating, for the SVW Provider, the interest crediting rate for the Policyholder which is typically reset at a predetermine time (e.g., quarterly). In some embodiments, the processing data for administering stable value products of the present invention is configured for accounting that the liability for the value of the SVW Financial product is based on a calculation of the value of the notional stable value account minus the Policyholder's share of the fair market value of the investment portfolio.

In some embodiments, the processing data for administering stable value products of the present invention is configured to account for an SVW Financial product that incorporates pooling where multiple Policyholders, each owning blocks of PPVUL policies issued by an Insurance Carrier, are (“Pooled”) together and wrapped with a single SVW Financial product (“Pooled SVW Financial product”). In some embodiments, with the “Pooling” configuration, the processing data for administering stable value products of the present invention is configured to allow the SVW Provider to provide a stable value crediting rate facility to a group of Policyholders where a notional stable value account is created for the group of Policyholders which accretes based on a single, non-negative interest crediting rate and tracks the Policyholders' share of an investment portfolio for the separate account investment option they have chosen. In some embodiments, the processing data for administering stable value products of the present invention is configured for calculating the cash value payable to each Policyholder upon surrender which can be the Policyholder's portion of the notional stable value account rather than the Policyholder's share of the fair market value of the investment portfolio. In some embodiments, the processing data for administering stable value products of the present invention is configured for calculating the interest crediting rate used to accrete the notional stable value account that is reset on a periodic basis based on the value of the notional stable value account, the fair market value of the entire Policyholders' share of the investment portfolio and various other variables specific to the Pooled SVW Financial product and the investment strategy. In some embodiments, the processing data for administering stable value products of the present invention is configured to allow the value of the notional stable value account to converge in a smooth (e.g., constant or nearly constant rate), non-decreasing progression to the fair market value of the entire Policyholders' share of the investment portfolio while avoiding fluctuations, and specifically decreases, in the fair market value of the Policyholders' share of the investment portfolio which occur with mark-to-market accounting used for separate accounts. In some embodiments, the processing data for administering stable value products of the present invention is configured so that the SVW Provider is required to pay under the Pooled SVW Financial product if (i) a Policyholder surrenders and that Policyholder's share of the notional stable value account exceeds the fair market value of the entire Policyholders' share of the investment portfolio and if the surrendering Policyholder meets qualifying conditions required for notional stable value account payouts which are stipulated in the Pooled SVW Financial product, or (ii) the entire Policyholders' share of the investment portfolio is depleted and there is an amount of positive notional stable value account remaining covered under the Pooled SVW Financial product.

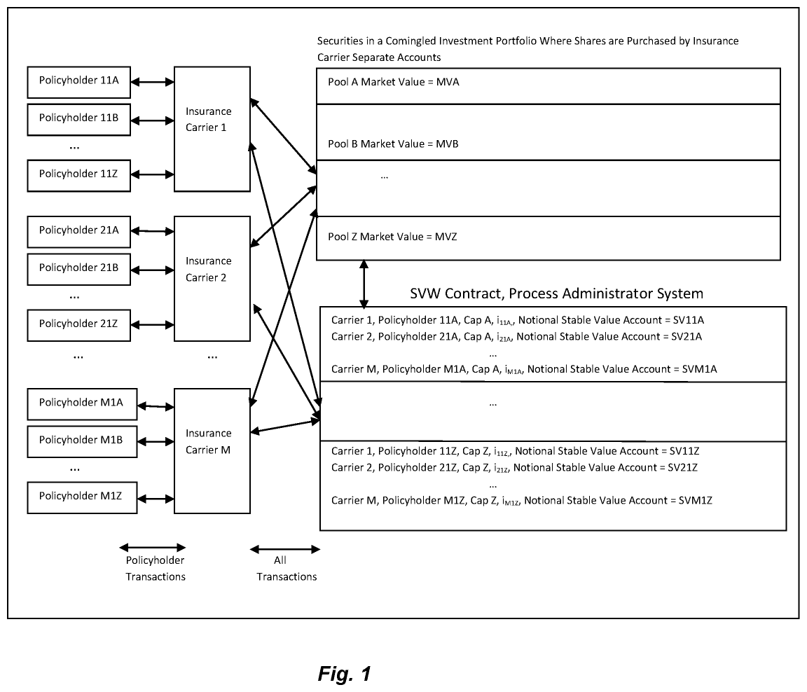

FIG. 1 illustrates certain daily processing attributes of a Pooled SVW Financial product with Capping and illustrates some aspects of the process/administration structure of some embodiments of the instant invention.

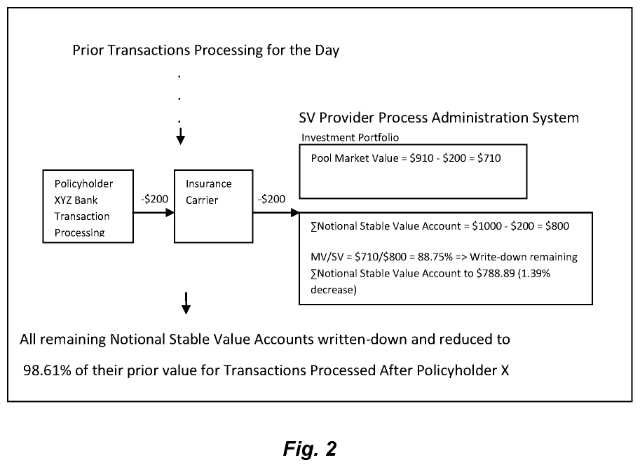

FIG. 2 illustrates a transaction that results in a write-down due to capping which may modify all subsequent transactions processed on that business day.

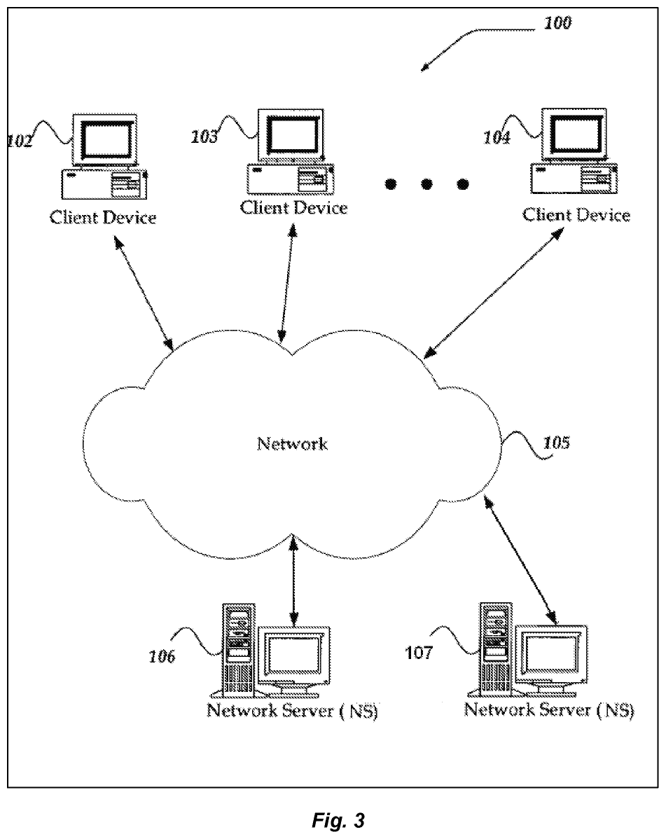

FIG. 3 illustrates a computer system according to some embodiments of the invention.

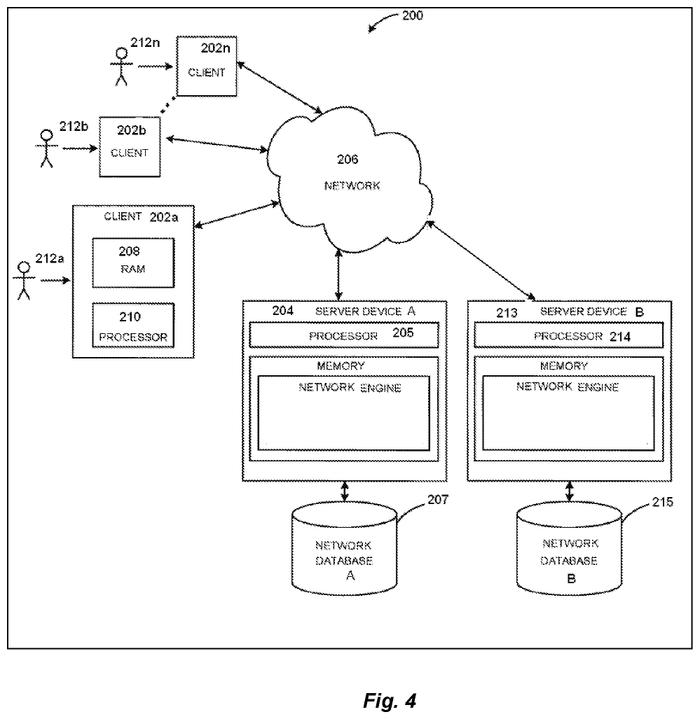

FIG. 4 illustrates yet another embodiment of the exchange computer and network architecture.

In some embodiments, the term “SVW Provider” is directed to an entity offering the SVW Financial product. In some embodiments, the term “Life Insurance Product” denotes a life insurance product, annuity product, fund and/or other investment portfolio. In some embodiments, the term “Policyholder” denotes an owner of the Life Insurance Product. In some embodiments, the term “Insurance Carrier” denotes the entity underwriting the Life Insurance Product. In some embodiments, the term “Life Insurance Data” denotes Life Insurance Product deductions, claims and/or Policyholder initiated transactions.

In some embodiments, the processing data for administering stable value products of the present invention is configured, utilizing specifically programmed computer methods and specifically programmed computer systems, for administering a Pooled SVW Financial product which incorporates risk reduction features for the SVW Provider including Pooling of multiple insurance Policyholders under the same SVW Financial product and limiting the maximum payout under the SVW Financial product using Capping, specifying a maximum payment or some other method, such financial product is referred herein as “Pooled SVW Financial product with Capping”. In some embodiments, the multiple Policyholders could own different Life Insurance Products. In some embodiments, the multiple Policyholders could own Life Insurance Products issued by the same Insurance Carrier, or in other embodiments, the multiple Policyholders could own Life Insurance Products issued by different Insurance Carriers. In some embodiments, the processing data for administering stable value products of the present invention is configured, utilizing specifically programmed computer methods and specifically programmed computer systems, for administering a Pooled SVW Financial product with Capping that further allows multiple independent investment portfolios for the same investment strategy covered under the Pooled SVW Financial product with Capping. In some embodiments, the processing data for administering stable value products of the present invention is configured, utilizing specifically programmed computer methods and specifically programmed computer systems, for administering a Pooled SVW Financial product with Capping that further allows different Capping limits for different Policyholders in an investment strategy. In some embodiments, the processing data for administering stable value products of the present invention is configured, utilizing specifically programmed computer methods and specifically programmed computer systems, for administering a Pooled SVW Financial product with Capping that further allows different Policyholders to have different interest crediting rates applicable to their share of the notional stable value account corresponding to the same investment strategy. In some embodiments, the processing data for administering stable value products of the present invention is configured, utilizing specifically programmed computer methods and specifically programmed computer systems, for administering a Pooled SVW Financial product with Capping that further allows different initial notional stable value account amounts for the same initial deposit into the investment portfolio. In some embodiments, the processing data for administering stable value products of the present invention is configured, utilizing specifically programmed computer methods and specifically programmed computer systems, for administering a Pooled SVW Financial product with Capping that further allows different SVW Financial product fees for different Policyholders.

FIG. 1 illustrates a non-limiting example of the processing data for administering stable value products of the present invention, utilizing specifically programmed computer methods and specifically programmed computer systems, for administering Pooled SVW Financial product with Multiple Capping Levels and Multiple Insurance Carriers. FIG. 1 illustrates receiving data over a computer network from distinct computer systems of relevant parties for processing data related to the administration requirements for such a Pooled SVW Financial product with Capping used in the COLI and BOLI markets in accordance with some embodiments of the instant invention. Multiple Policyholders from multiple Insurance Carriers, where each Policyholder owns multiple PPVUL policies, allocate their separate account investment to a comingled investment portfolio of securities wrapped by the Pooled SVW Financial product with Capping (“Wrapped Investment Portfolio”). FIG. 1 shows this as Policyholder 11A through Policyholder 11Z owning PPVUL policies issued by Carrier 1, Policyholder 21A through Policyholder 21Z owning PPVUL policies issued by Carrier 2, . . . , through Policyholder M1A through Policyholder M1Z owning policies issued by Carrier M. In some embodiments, investment amounts allocated to a Wrapped Investment Portfolio are used by the Insurance Carrier's separate account to purchase shares, and/or ownership rights, of the Wrapped Investment Portfolio. The Pooled SVW Financial product with Capping establishes classes of Policyholders in a Wrapped Investment Portfolio, where all Policyholders in a class have the same Cap. FIG. 1 shows this as Cap A, Cap B, . . . , Cap Z. The Wrapped Investment Portfolio is partitioned into separate pools for each class. Each pool owns its proportionate share of the underlying securities of the comingled investment portfolio based on the shares owned for each Policyholder in the class. FIG. 1 shows this as Pool A with market value MVA, Pool B with market value MVB, . . . , Pool Z with market value MVZ. Similarly, each Policyholder's notional stable value account is automatically tracked, utilizing specifically programmed computer methods and specifically programmed computer systems, for administering individually by the SVW Provider and the sum of notional stable value accounts for each Policyholder in a class determines the notional stable value account amount for the pool. FIG. 1 shows this for Pool A as Policyholder 11A with notional stable value account SV11A, Policyholder 21A with notional stable value account SV21A, . . . , through Policyholder M1A with notional stable value account SVM1A. The total notional stable value account amount for Pool A would be SV11A+SV21A+ . . . +SVM1A. Different interest crediting rates may apply to the notional stable value account of each Policyholder where the interest crediting rate is based, at least in part, on the Policyholder's Pool market value, Pool total notional stable value account amount, suitable parameters based on the Policyholder's initial market value investment and corresponding initial notional stable value account amount, past interest crediting rates and/or various suitable portfolio statistics for the comingled investment portfolio. FIG. 1 depicts this as i11A being the crediting rate for Policyholder 11A, etc. FIG. 1 depicts one investment strategy, but the process can be extended to multiple investment strategies. In some embodiments, the processing data for administering stable value products of the present invention is configured, utilizing specifically programmed computer methods and specifically programmed computer systems, for administering the Pooled SVW Financial product with Capping which requires that the SVW Provider be more involved with the Insurance Carrier's daily processing of transactions so that once-per-calendar-quarter catch-up processing by the SVW Provider is no longer viable. In some embodiments, the processing data for administering stable value products of the present invention is configured, utilizing specifically programmed computer methods and specifically programmed computer systems, for an immediate electronic notification transmitted over a computer network to a computer system of the SVW Provider to cause write-down testing and/or processing associated with Capping which must be immediately, in real-time, performed when many transactions occur. In some embodiments, a write-down due to Capping associated with a transaction from one Policyholder could result in required modifications to other transactions that were submitted the same day by other Policyholders. In some embodiments, the processing data for administering stable value products of the present invention is configured, utilizing specifically programmed computer methods and specifically programmed computer systems, for allowing the SVW Provider to perform write-down testing associated with Capping and electronically in real time communicate modifications back, over the computer network, from its computer system to computer systems of all participating Insurance Carriers, when there is the occurrence of any transaction generating modification(s), in order for all Insurance Carriers to timely trade the appropriate amount for the modified transactions and avoid gains or losses due to market fluctuations occurring between the date of the transaction and the date of the correct trade. In addition, the SVW Provider must have up-to-date values of the Pool market value, the Pool total notional stable value account, and each Policyholder's notional stable value account in order to perform the write-down test associated with Capping which means all transactions and fair market valuations occurring prior to the write-down test must be reported to the SVW Provider. In some embodiments, the processing data for administering stable value products of the present invention is configured, utilizing specifically programmed computer methods and specifically programmed computer systems, for allowing, under PPVUL policies, Policyholder initiated transactions and/or claims to occur on any business day, and most PPVUL policies may be issued on any day of a month and thus require processing of PPVUL deductions on that same day for every month of the year, which means reporting to the SVW Provider and write-down testing due to Capping must be part of the SVW Provider's daily administration process. In some embodiments, the processing data for administering stable value products of the present invention is configured, utilizing specifically programmed computer methods and specifically programmed computer systems, for administering certain transactions that are processed at market value, which means the amount of the transaction which is liquidated from the comingled investment portfolio is multiplied by the ratio of the Pool market value to the Pool total notional stable value account, will not be modified by write-downs due to Capping so market value transactions can be immediately processed and submitted for trading by the Insurance Carrier. Other transactions, those that are processed at stable value, which means the amount of the transaction is liquidated from the comingled investment portfolio, may be subject to modification from a write-down due to Capping that occurs with a stable value transaction from any Policyholder. In some embodiments, the processing data for administering stable value products of the present invention is configured, utilizing specifically programmed computer methods and specifically programmed computer systems, for electronically reporting all transactions in real time to a computer system of SVW Provider promptly upon their occurrence, and that allowing the Insurance Carrier to receive a verification of the final value for stable value transactions before processing and submitting stable value transactions for trades to avoid incorrect trades. In some embodiments, the processing data for administering stable value products of the present invention is configured, utilizing specifically programmed computer methods and specifically programmed computer systems, for electronically storing in non-transient computer memory, for the SVW Provider, current values for all Policyholder notional stable value accounts and each Pool market value on every day a stable value transaction occurs. In some embodiments, the processing data for administering stable value products of the present invention is configured, utilizing specifically programmed computer methods and specifically programmed computer systems, for resetting, by the SVW Provider, interest crediting rates on, but not limited to, a periodic basis

As shown in FIG. 1, in some embodiments, the processing data for administering stable value products of the present invention is configured, utilizing specifically programmed computer methods and specifically programmed computer systems, for Insurance Carrier and SVW Provider Periodic administering (e.g., valuation, processing, and/or calculation) which occurs every day if there is a transaction (but at a minimum, for example, monthly).

As shown in FIG. 1, in some embodiments, all securities in the comingled investment portfolio are valued every day for which a transaction occurs as well as at certain periodic times each month at fair market value. In some embodiments, total market value of the investment portfolio equals MVA+MVB+ . . . +MVZ. MVA is partitioned out to Pool A based on Policyholders' with Cap A proportional ownership of the total investment portfolio. MBV is partitioned out to Pool B based on Policyholders' with Cap B proportional ownership of the total investment portfolio, and so on through Pool Z.

As shown in FIG. 1, in some embodiments, the processing data for administering stable value products of the present invention is configured, utilizing specifically programmed computer methods and specifically programmed computer systems, for allowing each Insurance Carrier to process transactions (e.g., PPVUL deductions, claims and/or Policyholder initiated transactions) on each day they occur, and/or as specified in the financial products. In some embodiments, the processing data for administering stable value products of the present invention is configured, utilizing specifically programmed computer methods and specifically programmed computer systems, for administering Policyholder initiated transactions which require pre-approval from the SVW Provider. In some embodiments, the processing data for administering stable value products of the present invention is configured, utilizing specifically programmed computer methods and specifically programmed computer systems, for electronically identifying those transactions that cannot be modified by the SVW Provider as specified in the SVW Financial product to the Insurance Carrier which can immediately process in real time those transactions and submit trades to the comingled investment portfolio for those transactions. Trading for those transactions that may be modified by the SVW Provider must be held until final transaction values are verified by the SVW Provider. All transactions must be reported to the SVW Provider each day they occur.

As shown in FIG. 1, in some embodiments, the SVW Provider receives all transactions for the day from the Insurance Carriers as well as certain comingled investment portfolio statistics from the money manager.

As shown in FIG. 1, in some embodiments, the SVW Provider updates the notional stable value account for each Policyholde as follows.
a) Interest is credited
SV11A is credited at an interest rate of i11A,
SV21A is credited at an interest rate of i21A,
SVM1Z is credited at an interest rate of iM1Z.
b) Each Policyholder's notional stable value account is updated for those transactions that may be processed by the Insurance Carrier without modification from the SVW Provider.
c) Write-downs to the notional stable value accounts for impaired securities are processed.
d) Capping testing followed by notional stable value account write-downs (see e), if necessary, may occur at various times in the SVW Provider's daily processing.

In some embodiments, the processing data for administering stable value products of the present invention is configured, utilizing specifically programmed computer methods and specifically programmed computer systems, for accounting notional stable value account write-downs which may affect transactions that have not yet been processed in the daily cycle. In some embodiments, a Policyholder by Policyholder order is established for certain transactions so that the transaction for the first Policyholder in the order is processed, followed by capping testing with write-downs, if necessary, that may affect all transaction that have not been processed yet in the daily cycle. Then the transaction (or the modified transaction if a write-down occurred) for the second Policyholder is processed, followed by capping testing and write-downs, if necessary, and so on until the final transaction (or its modified amount if write-downs occurred) for the day is processed, followed by capping testing and write-downs, if necessary.
e) Capping testing

The amount of the notional stable value account, SV**X, for each Policyholder in Pool X of the comingled investment portfolio, may be written down if: ΣSV**X−MVX>Cap X*ΣSV**X, where X€{A, B, . . . , Z}, and ΣSV**X is the sum of the notional stable value amounts for all Policyholders with cap X where each Policyholder's notional stable value account has been updated for all prior transactions processed before the capping test. MVX is based on Pool X's proportionate share of the MV of the comingled investment portfolio following all prior transactions processed before the capping test. To the extent a transaction which hasn't been processed for the day exceeds the written-down SV**X, then that transaction must be reduced to equal the written down SV**X.
f) The verified, or modified, amounts for those transactions that may be modified by the SVW Provider are reported back to the Insurance Carriers.

As shown in FIG. 1, in some embodiments, the Insurance Carriers receive verified, or modified, amounts for those transactions that may be modified by the SVW Provider. Each Insurance Carrier processes such transactions and submits trades to the comingled investment portfolio.

As illustrated in FIG. 1, the processing data for administering stable value products of the present invention is configured, utilizing specifically programmed computer methods and specifically programmed computer systems, for interacting, over computer network, with computer systems of multiple Insurance Carriers and the asset manager(s) in accordance with some embodiments of the instant invention. In some embodiments, the processing data for administering stable value products of the present invention is configured, utilizing specifically programmed computer methods and specifically programmed computer systems, for administering investment options in a Life Insurance Product, by, automatically and/or periodically, receiving necessary data from the respective parties, processing the data, and communicating results back.

In some embodiments, FIG. 2, Transaction Caused Write-Down Due to Capping, shows one illustrative, non-limiting sequence in the daily processing cycle performed by a specifically programmed computer system of an SVW Provider where Policyholder XYZ Bank wants a $200 withdrawal from a Life Insurance Product under a Pooled SVW Financial product with Capping. The cap is 10%, the pre-withdrawal market value of the investment portfolio for all Policyholders is $910, and the pre-withdrawal total notional stable value account for all Policyholders is $1000. This example shows how one Policyholder's transaction could impact another Policyholder's transaction which is processed later in the day, and why the SVW Provider must test transactions daily and report modifications back to the Insurance Carrier so that processing and trading can occur promptly and accurately. Prior to this withdrawal, one minus the ratio of the market value of the Policyholders' share of the investment portfolio to the Policyholders' notional stable value account is 1−$910/$1000=9% which is below the Cap maximum of 10%. Upon completion of Policyholder XYZ Bank's $200 withdrawal, $200 is caused, by the specialize computer system of the instant invention, to be automatically deducted from both the Policyholders' share of the investment portfolio and the Policyholders' notional stable value account. Checking for the Cap limitation, we have one minus the ratio of the market value of the Policyholders' share of the investment portfolio to the Policyholders' notional stable value account is 1−$710/$800=11.25% which exceeds the Cap of 10%. This means the remaining Policyholders' notional stable value account must be reduced by $11.11 to $788.89 so that the resulting one minus the ratio of the market value of the Policyholders' share of the investment portfolio to the Policyholders' notional stable value account is 1−$710/$788.89=10% and the Cap is no longer breached. An $11.11 reduction is a 1.39% decrease which must be applied, utilizing specifically programmed computer methods and specifically programmed computer systems, to all remaining Policyholder's share of the total notional stable value account before processing of the next transaction for the day occurs. For example, if another Policyholder owned $300 of notional stable value account and wanted to withdraw the entire amount and their transaction is processed after Policyholder XYZ Bank, then the $300 transaction request must be modified by a 1.39% decrease to a $295.83 withdrawal request.

Some embodiments of the instant invention as detailed herein allow the SVW Provider to administer Pooled SVW Financial product with Capping which require, at a minimum, the ability to perform daily processing and communication in order to meet the timing requirements for prompt trading of securities required in PPVUL financial products which offer Pooled SVW Financial products with Capping as part of an investment choice. For example, in some scenarios, PPVUL Policyholder initiated transactions must be received by 4 PM EDT on a business day, and those transactions along with any insurance deductions for the day must be processed and communicated for trading to the investment manager by 10 AM EDT the following business day and in no case later than three business days in order to avoid gains and losses from fluctuations in the market value of securities between the time of the transaction and the time of the trade

Some embodiments of the instant invention as detailed herein allow the SVW Provider to administer Pooled SVW Financial product with Capping which requires, the storage of all insurance data, modifications to such data, and investment data over a extended period of time (e.g., several months, year, several years, etc.). In some embodiments, the processing data for administering stable value products of the present invention is configured, utilizing specifically programmed computer methods and specifically programmed computer systems, for identifying and/or correcting errors in reported insurance data and investment data which may be discovered far after such data is originally reported, which may require reprocessing and recalculation of all amounts calculated subsequent to such error. In some embodiments, the processing data for administering stable value products of the present invention is configured, utilizing specifically programmed computer methods and specifically programmed computer systems, for administering audits and financial statements are generally performed where all transactions and calculations for the prior calendar year are reviewed and reported. In some embodiments, the processing data for administering stable value products of the present invention is configured, utilizing specifically programmed computer methods and specifically programmed computer systems, to account for legal requirements that may create the necessity for the SVW Provider to recreate one Policyholder's notional stable value account from inception, and since transactions from other Policyholders may result in modifications to any other Policyholder's transactions under the Pooled SVW Financial product with Capping, all transactions for all Policyholders since inception of such Policyholder are needed to recreate such Policyholder's notional stable value account from inception.

In some embodiments, the processing data for administering stable value products of the present invention is configured, utilizing specifically programmed computer methods and specifically programmed computer systems, to employ one or more computer/processors with sufficient computational power to process data for administering, at a minimum, 10 Policyholders and $100 million of assets over a one year period because of at least one of, but not limited to:
(i) such administration involves multiple Insurance Carrier systems with diverse structures in everything from hardware to software;
(ii) there are diverse Life Insurance Products and no industry standard with respect to Life Insurance Product structure, terminology or methodology;
(iii) the SVW Provider's Process Administrator System must be as accurate and efficient as, and have at least a processing speed equivalent to, that found in each Insurance Carrier system;
(iv) the SVW Provider's Process Administrator System must be able to verify transactions, or calculate modifications to such transactions, and report back to the Insurance Carrier within a time frame that allows the Insurance Carrier to submit trades to investment managers for such transactions and not be subject to gains and losses due to market fluctuations occurring between the time of the transaction and the time of the trade, and
(v) The SVW Provider's Process Administrator System must store all transactions and modifications of such transactions and investment data for long periods of time.

In some embodiments, the instant invention is directed to a computer-implemented method that at least includes the steps of: electronically and periodically receiving, over a computer network, from at least one computer system associated with at least one life insurance carrier, by a specifically programmed data processing computer system, life insurance data for a plurality of policyholders associated with at least one pooled stable value wrap (SVW) financial product having a predetermine capping; where the at least one pooled stable value wrap (SVW) financial product covers: (i) at least 10 policyholders, (ii) at least $100 million of a notional stable value account, and (iii) at least a one year period of operation; where the predetermined capping is an X percent limit to be maintained for a ratio of a pre-withdrawal fair market value of an investment portfolio to a pre-withdrawal total notional stable value account for the at least 10 policyholders; automatically classifying, by the specifically programmed data processing computer system, in real time, at least one first policyholder into at least one class based on the predetermined capping applicable to the at least one first policyholder; electronically and periodically receiving, by the specifically programmed data processing computer system, over the computer system, from a computer system associated with a financial trading institution, investment data resulted from investing in at least one investment option associated with the at least one pooled SVW financial product with the predetermined capping; automatically partitioning, by the specifically programmed data processing computer system, in real time, investment assets, underlying the at least one investment option associated with the pooled SVW financial product with the predetermined capping, into at least one investment pool, based, at least in part, on an ownership share in the investment assets of the at least one first policyholder in the at least one class based on the predetermined capping applicable to the at least one first policyholder; automatically calculating, by the specifically programmed data processing computer system, in real time, at least one interest crediting rate to be credited to a first notional stable value account for the at least one first policyholder based, at least in part, on: i) the life insurance data, and ii) the investment data; automatically calculating, by the specifically programmed data processing computer system, in real time, the pre-withdrawal fair market value of the at least one investment pool, based, at least in part, on: i) the life insurance data, and ii) the investment data; automatically calculating, by the specifically programmed data processing computer system, in real time a first pre-withdrawal total notional stable value account for the at least one first policyholder based, at least in part, on: i) the at least one interest crediting rate to be credited to the first notional stable value account for the at least one first policyholder, and ii) the life insurance data; automatically calculating, by the specifically programmed data processing computer system, in real time, any modifications to the life insurance data, based at least in part, on: i) the pre-withdrawal fair market value of the at least one investment pool, ii) the first pre-withdrawal total notional stable value account for the at least one first policyholder, and iii) a write-down testing for the class based on the predetermined capping for the at least one first policyholder; electronically and automatically transmitting, by the specifically programmed data processing computer system, in real time, verification of the life insurance data or modifications to the life insurance data back to the computer system associated with the at least one life insurance carrier.

In some embodiments, the at least one investment option includes an actively managed investment strategy.

In some embodiments, the transmitting of the life insurance data or modifications to the life insurance data back to the at least one life insurance carrier is performed within 3 business days after the investment data is received.

In some embodiments, the life insurance data includes at least one of the following: (a) allocations, (b) net premium deposits, (c) loan repayments, (d) partial surrenders, (e) surrenders, (f) loans, (g) death benefits, (h) transfers between investment alternatives, and (i) life insurance product deductions.

In some embodiments, the pooled SVW financial product with the predetermined capping is utilized by more than one insurance carrier and the life insurance data is received from more than one life insurance carrier.

In some embodiments, the pooled SVW financial product with the predetermined capping is associated with more than one investment option.

In some embodiments, the investment data is received from multiple independent investment portfolios for the same investment option.

In some embodiments, the instant invention is directed to a computer-implemented system, including at least the following components: at least one specialized computer machine, including: a non-transient memory having at least one region for storing a particular computer executable program code; and at least one processor for executing the particular program code stored in the non-transient memory, where the particular program code is configured to at least perform the following operations upon being executed by the at least one processor: electronically and periodically receiving, over a computer network, from at least one computer system associated with at least one life insurance carrier life insurance data for a plurality of policyholders associated with at least one pooled stable value wrap (SVW) financial product having a predetermine capping; where the at least one pooled stable value wrap (SVW) financial product covers: (i) at least 10 policyholders, (ii) at least $100 million of a notional stable value account, and (iii) at least a one year period of operation; where the predetermined capping is an X percent limit to be maintained for a ratio of a pre-withdrawal fair market value of an investment portfolio to a pre-withdrawal total notional stable value account for the at least 10 policyholders; automatically classifying, in real time, at least one first policyholder into at least one class based on the predetermined capping applicable to the at least one first policyholder; electronically and periodically receiving, over the computer system, from a computer system associated with a financial trading institution, investment data resulted from investing in at least one investment option associated with the at least one pooled SVW financial product with the predetermined capping; automatically partitioning, in real time, investment assets, underlying the at least one investment option associated with the pooled SVW financial product with the predetermined capping, into at least one investment pool, based, at least in part, on an ownership share in the investment assets of the at least one first policyholder in the at least one class based on the predetermined capping applicable to the at least one first policyholder; automatically calculating, in real time, at least one interest crediting rate to be credited to a first notional stable value account for the at least one first policyholder based, at least in part, on: i) the life insurance data, and ii) the investment data; automatically calculating, in real time, the pre-withdrawal fair market value of the at least one investment pool, based, at least in part, on: i) the life insurance data, and ii) the investment data; automatically calculating, in real time a first pre-withdrawal total notional stable value account for the at least one first policyholder based, at least in part, on: i) the at least one interest crediting rate to be credited to the first notional stable value account for the at least one first policyholder, and ii) the life insurance data; automatically calculating, in real time, any modifications to the life insurance data, based at least in part, on: i) the pre-withdrawal fair market value of the at least one investment pool, ii) the first pre-withdrawal total notional stable value account for the at least one first policyholder, and iii) a write-down testing for the class based on the predetermined capping for the at least one first policyholder; and electronically and automatically transmitting, in real time, verification of the life insurance data or modifications to the life insurance data back to the computer system associated with the at least one life insurance carrier.

Illustrative Operating Computer Environments in Accordance with Some Embodiments

FIG. 3 illustrates a computer system in accordance with some embodiments of the present invention. However, not all of these components may be required to practice the invention, and variations in the arrangement and type of the components may be made without departing from the spirit or scope of the invention. In some embodiment, the inventive exchange system hosts a large number of members and concurrent transactions. In other embodiments, the inventive exchange computer system is based on a scalable computer and network architecture that incorporates varies strategies for assessing the data, caching, searching, and database connection pooling. An example of the scalable architecture is an architecture that is capable of operating multiple servers. In embodiments, the computing system in accordance with the instant invention may include, but not limiting to, one or more programmed computers, systems employing distributed networking, or other type of system that might be used to transmit and process electronic data.

In embodiments, client devices (e.g., computer systems of Insurance Carrier(s), asset manager(s), and/or SVW Provider(s)) 102-104 include virtually any computing device capable of receiving and sending a message over a network, such as network 105, to and from another computing device, such as servers (e.g., the processing data computer system, including at least one specialized computer machine) 106 and 107, each other, and the like. In embodiments, the set of such devices includes devices that typically connect using a wired communications medium such as personal computers, multiprocessor systems, microprocessor-based or programmable consumer electronics, network PCs, and the like. In embodiments, the set of such devices also includes devices that typically connect using a wireless communications medium such as cell phones, smart phones, pagers, walkie talkies, radio frequency (RF) devices, infrared (IR) devices, CB s, integrated devices combining one or more of the preceding devices, or virtually any mobile device, and the like. Similarly, in embodiments, client devices 102-104 are any device that is capable of connecting using a wired or wireless communication medium such as a PDA, POCKET PC, wearable computer, and any other device that is equipped to communicate over a wired and/or wireless communication medium.

In embodiments, client devices 102-104 are further configured to receive a message from the another computing device employing another mechanism, including, but not limited to email, Short Message Service (SMS), Multimedia Mess age Service (MMS), instant messaging (IM), internet relay chat (IRC), mIRC, Jabber, and the like.

In embodiments, network 105 is configured to couple one computing device to another computing device to enable them to communicate. In embodiments, network 605 is enabled to employ any form of computer readable media for communicating information from one electronic device to another. Also, in embodiments, network 105 includes a wireless interface, and/or a wired interface, such as the Internet, in addition to local area networks (LANs), wide area networks (WANs), direct connections, such as through a universal serial bus (USB) port, other forms of computer-readable media, or any combination thereof. In embodiments, on an interconnected set of LANs, including those based on differing architectures and protocols, a router acts as a link between LANs, enabling messages to be sent from one to another.

Also, in some embodiments, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, in embodiments, remote computers and other related electronic devices could be remotely connected to either LANs or WANs via a modem and temporary telephone link. In essence, in embodiments, network 105 includes any communication method by which information may travel between client devices 102-104, and servers 106 and 107.

FIG. 4 shows another exemplary embodiment of the exchange computer and network architecture that supports a computer exchange system in accordance with some embodiments of the instant invention. The client devices 202a, 202b thru 202n (e.g., computer systems of Insurance Carrier(s), asset manager(s), and/or SVW Provider(s)) shown each comprises a computer-readable medium, such as a random access memory (RAM) 208 coupled to a processor 210. The processor 210 executes computer-executable program instructions stored in memory 208. Such processors comprise a microprocessor, an ASIC, and state machines. Such processors comprise, or are be in communication with, media, for example computer-readable media, which stores instructions that, when executed by the processor, cause the processor to perform the steps described herein. Embodiments of computer-readable media include, but are not limited to, an electronic, optical, magnetic, or other storage or transmission device capable of providing a processor, such as the processor 210 of client 202a, with computer-readable instructions. Other examples of suitable media include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media transmit or carry instructions to a computer, including a router, private or public network, or other transmission device or channel, both wired and wireless. The instructions comprise code from any computer-programming language, including, for example, C, C++, C#, Visual Basic, Java, Python, Perl, and JavaScript.

Client devices 202a-n also comprise a number of external or internal devices such as a mouse, a CD-ROM, DVD, a keyboard, a display, or other input or output devices. Examples of client devices 202a-n are personal computers, digital assistants, personal digital assistants, cellular phones, mobile phones, smart phones, pagers, digital tablets, laptop computers, Internet appliances, and other processor-based devices. In general, a client device 202a are be any type of processor-based platform that is connected to a network 206 and that interacts with one or more application programs. Client devices 202a-n operate on any operating system capable of supporting a browser or browser-enabled application, such as Microsoft™, Windows™, or Linux. The client devices 202a-n shown include, for example, personal computers executing a browser application program such as Microsoft Corporation's Internet Explorer™, Apple Computer, Inc.'s Safari™, Mozilla Firefox, and Opera.

Through the client devices 202a-n, Insurance Carrier(s), asset manager(s), and/or SVW Provider(s) 212a-n communicate over the network 206 with each other and with other systems and devices coupled to the network 206. As shown in FIG. 4, server devices 204 and 213 (e.g., the processing data computer system, including at least one specialized computer machine) are also coupled to the network 206.

Of note, the embodiments described herein may, of course, be implemented using any appropriate computer system hardware and/or computer system software. In this regard, those of ordinary skill in the art are well versed in the type of computer hardware that may be used (e.g., a mainframe, a mini-computer, a personal computer (“PC”), a network (e.g., an intranet and/or the internet)), the type of computer programming techniques that may be used (e.g., object oriented programming), and the type of computer programming languages that may be used (e.g., C++, Basic, AJAX, Javascript). The aforementioned examples are, of course, illustrative and not restrictive.

In some embodiments, the instant invention is directed to a computer-implemented method which includes at least the following steps of programming a Process Administrator computer system (e.g., the processing data computer system, including at least one specialized computer machine) to perform at least: receiving Life Insurance Data for a plurality of Policyholders associated with a Pooled SVW Financial product with Capping with: (i) at least 10 Policyholders, and (ii) at least $100 million of notional stable value account, and (iii) at least a one year period of operation; classifying, the at least one first Policyholder into at least one class based on the Cap applicable to the at least one first Policyholder; receiving, investment data resulted from investing, in at least one investment option, associated with the Pooled SVW Financial product with Capping; partitioning, the investment assets, other than the Pooled SVW Financial product with Capping, underlying the at least one investment option, associated with the Pooled SVW Financial product with Capping, into at least one Pool, based on the ownership share in the investment assets of the at least one first Policyholder in the class based on the Cap applicable to the at least one first Policyholder; calculating, at least one interest crediting rate to be credited to the notional stable value account for the at least one first Policyholder based, at least in part, on: the Life Insurance Data, and the investment data; calculating, the fair market value of the at least one Pool, based, at least in part, on: the Life Insurance Data, and the investment data; calculating, at least one notional stable value account for the at least one first Policyholder based, at least in part, on: i) the at least one interest crediting rate to be credited to the notional stable value account for the at least one first Policyholder, and ii) the Life Insurance Data; calculating, any modifications to the Life Insurance Data, based at least in part, on: the fair market value of the at least one Pool, i) the at least one notional stable value account for the at least one first Policyholder, and ii) the write-down testing for the class based on the Cap for the at least one first Policyholder; transmitting verification of the Life Insurance Data or modifications to the Life Insurance Data back to the Insurance Carrier.

In some embodiments, the at least one investment option comprises an actively managed investment strategy.

In some embodiments, the transmitting of the Life Insurance Data or modifications to the Life Insurance Data back to the Insurance Carrier is performed within 3 business days after the investment data is received.

In some embodiments, the steps are performed on a pre-determined periodic time basis.

In some embodiments, the steps are performed on each time the Life Insurance Data is received.

In some embodiments, the Life Insurance Data comprises at least one of the following:
(a) allocations,
(b) net premium deposits,
(c) loan repayments,
(d) partial surrenders,
(e) surrenders,
(f) loans,
(g) death benefits,
(h) transfers between investment alternatives, and
(i) Life Insurance Product deductions.

In some embodiments, the Pooled SVW Financial product with Capping is utilized by more than one Insurance Carrier and the Life Insurance Data is received from more than one Insurance Carrier.

In some embodiments, the Pooled SVW Financial product with Capping is associated with more than one investment option.

In some embodiments, the investment data is received from multiple independent investment portfolios for the same investment option.

While a number of embodiments of the present invention have been described, it is understood that these embodiments are illustrative only, and not restrictive, and that many modifications may become apparent to those of ordinary skill in the art. Further still, the various steps may be carried out in any desired order (and any desired steps may be added and/or any desired steps may be eliminated).

What is claimed is:

1. A computer-implemented method, comprising:
electronically and periodically receiving, over a computer network, from at least one computer system associated with at least one life insurance carrier, by a specifically programmed data processing computer system, life insurance data for a plurality of policyholders associated with at least one pooled stable value wrap (SVW) financial product having a predetermine capping;
wherein the predetermined capping is an X percent limit to be maintained for a ratio of a pre-withdrawal fair market value of an investment portfolio to a pre-withdrawal total notional stable value account for the at least 10 policyholders;
automatically classifying, by the specifically programmed data processing computer system, in real time, at least one first policyholder into at least one class based on the predetermined capping applicable to the at least one first policyholder;
electronically and periodically receiving, by the specifically programmed data processing computer system, over the computer system, from a computer system associated with a financial trading institution, investment data resulted from investing in at least one investment option associated with the at least one pooled SVW financial product with the predetermined capping;
automatically partitioning, by the specifically programmed data processing computer system, in real time, investment assets, underlying the at least one investment option associated with the pooled SVW financial product with the predetermined capping, into at least one investment pool, based, at least in part, on an ownership share in the investment assets of the at least one first policyholder in the at least one class based on the predetermined capping applicable to the at least one first policyholder;
automatically calculating, by the specifically programmed data processing computer system, in real time, at least one interest crediting rate to be credited to a first notional stable value account for the at least one first policyholder based, at least in part, on:
i) the life insurance data, and
ii) the investment data;
automatically calculating, by the specifically programmed data processing computer system, in real time, the pre-withdrawal fair market value of the at least one investment pool, based, at least in part, on:
i) the life insurance data, and
ii) the investment data;
automatically calculating, by the specifically programmed data processing computer system, in real time a first pre-withdrawal total notional stable value account for the at least one first policyholder based, at least in part, on:
i) the at least one interest crediting rate to be credited to the first notional stable value account for the at least one first policyholder, and
ii) the life insurance data;
automatically calculating, by the specifically programmed data processing computer system, in real time, any modifications to the life insurance data, based at least in part, on:
i) the pre-withdrawal fair market value of the at least one investment pool,
ii) the first pre-withdrawal total notional stable value account for the at least one first policyholder, and
iii) a write-down testing for the class based on the predetermined capping for the at least one first policyholder;
electronically and automatically transmitting, by the specifically programmed data processing computer system, in real time, verification of the life insurance data or modifications to the life insurance data back to the computer system associated with the at least one life insurance carrier.

2. The method of claim 1, wherein the at least one investment option comprises an actively managed investment strategy.

3. The method of claim 1, wherein the transmitting of the life insurance data or modifications to the life insurance data back to the at least one life insurance carrier is performed within 3 business days after the investment data is received.

4. The method of claim 1, wherein the life insurance data comprises at least one of the following:
(a) allocations,
(b) net premium deposits,
(c) loan repayments,
(d) partial surrenders,
(e) surrenders,
(f) loans,
(g) death benefits,
(h) transfers between investment alternatives, and
(i) life insurance product deductions.

5. The method of claim 1, wherein the pooled SVW financial product with the predetermined capping is utilized by more than one insurance carrier and the life insurance data is received from more than one life insurance carrier.

6. The method of claim 1, wherein the pooled SVW financial product with the predetermined capping is associated with more than one investment option.

7. The method of claim 1, wherein the investment data is received from multiple independent investment portfolios for the same investment option.

8. A processing data computer system, comprising:
at least one specialized computer machine, comprising:
a non-transient memory having at least one region for storing a particular computer executable program code; and
at least one processor for executing the particular program code stored in the non-transient memory, wherein the particular program code is configured to at least perform the following operations upon being executed by the at least one processor:
electronically and periodically receiving, over a computer network, from at least one computer system associated with at least one life insurance carrier life insurance data for a plurality of policyholders associated with at least one pooled stable value wrap (SVW) financial product having a predetermine capping;
wherein the predetermined capping is an X percent limit to be maintained for a ratio of a pre-withdrawal fair market value of an investment portfolio to a pre-withdrawal total notional stable value account for the at least 10 policyholders;
automatically classifying, in real time, at least one first policyholder into at least one class based on the predetermined capping applicable to the at least one first policyholder;
electronically and periodically receiving, over the computer system, from a computer system associated with a financial trading institution, investment data resulted from investing in at least one investment option associated with the at least one pooled SVW financial product with the predetermined capping;
automatically partitioning, in real time, investment assets, underlying the at least one investment option associated with the pooled SVW financial product with the predetermined capping, into at least one investment pool, based, at least in part, on an ownership share in the investment assets of the at least one first policyholder in the at least one class based on the predetermined capping applicable to the at least one first policyholder;
automatically calculating, in real time, at least one interest crediting rate to be credited to a first notional stable value account for the at least one first policyholder based, at least in part, on:
i) the life insurance data, and
ii) the investment data;
automatically calculating, in real time, the pre-withdrawal fair market value of the at least one investment pool, based, at least in part, on:
i) the life insurance data, and
ii) the investment data;
automatically calculating, in real time a first pre-withdrawal total notional stable value account for the at least one first policyholder based, at least in part, on:
i) the at least one interest crediting rate to be credited to the first notional stable value account for the at least one first policyholder, and
ii) the life insurance data;
automatically calculating, in real time, any modifications to the life insurance data, based at least in part, on:
i) the pre-withdrawal fair market value of the at least one investment pool,
ii) the first pre-withdrawal total notional stable value account for the at least one first policyholder, and
iii) a write-down testing for the class based on the predetermined capping for the at least one first policyholder; and
electronically and automatically transmitting, in real time, verification of the life insurance data or modifications to the life insurance data back to the computer system associated with the at least one life insurance carrier.

9. The computer system of claim 8, wherein the at least one investment option comprises an actively managed investment strategy.

10. The computer system of claim 8, wherein the transmitting of the life insurance data or modifications to the life insurance data back to the at least one life insurance carrier is performed within 3 business days after the investment data is received.

11. The computer system of claim 8, wherein the life insurance data comprises at least one of the following:
(a) allocations,
(b) net premium deposits,
(c) loan repayments,
(d) partial surrenders,
(e) surrenders,
(f) loans,
(g) death benefits,
(h) transfers between investment alternatives, and
(i) life insurance product deductions.

12. The computer system of claim 8, wherein the pooled SVW financial product with the predetermined capping is utilized by more than one insurance carrier and the life insurance data is received from more than one life insurance carrier.

13. The computer system of claim 8, wherein the pooled SVW financial product with the predetermined capping is associated with more than one investment option.

14. The computer system of claim 8, wherein the investment data is received from multiple independent investment portfolios for the same investment option.
